(19) United States
(12) Patent Application Publication
(10) Pub. No.: US 2009/0167734 A1
(43) Pub. Date: Jul. 2, 2009

(54) FLAT DISPLAY AND METHOD OF DRIVING THE SAME

(75) Inventors: Chan CHIAN-HUNG, Tainan County (TW); Kuo-Shiuan PENG, Tainan County (TW); Yueh-Jui LI, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/342,550

(22) Filed: Dec. 23, 2008

(30) Foreign Application Priority Data
Dec. 28, 2007 (TW) 96150966

(51) Int. Cl. G06F 3/038; G09G 3/36

(52) U.S. Cl. 345/205; 345/89

(57) ABSTRACT

In a method of driving a flat display having a first pixel and a second pixel, the first pixel is driven to a first gray level and the second pixel is driven to a second gray level during the first sub-frame period of a frame period. The first pixel is driven to a third gray level and the second pixel is driven to a fourth gray level during the second sub-frame period of the frame period. The first gray level is different from the third gray level, with the average value of the first and the third gray level is equal to a first target gray level. The second gray level is different from the fourth gray level, with the average value of the second and the fourth gray level is equal to a second target gray level.

This application claims the benefit of Taiwan application Serial No. 96150966, filed Dec. 28, 2007, the entire disclosure of which is incorporated herein by reference.

### BACKGROUND

The disclosure relates in general to a flat display and a method of driving the same, and in some embodiments, a flat display and method of driving the same for resolving the problem of flickering frame.

The motion blur problem that occurs in a liquid crystal display adopting a hold type driving method has been an imminent issue to many manufacturers in the past few years, and the impulse-driving method is a solution that has been provided in recent years.

According to the impulse-driving method, the motion blur problem is resolved by inserting a black frame periodically into each frame period of a motion picture to reduce the duration of the image of the previous frame period in the viewer's eyes. As the insertion of black frame shortens the duration of light transmittance in each frame period, the average luminance of overall pixels largely deteriorates despite the luminance of the pixels of the liquid crystal display adopting the impulse-driving method can be outputted impulsively. Therefore, the practicality of the impulse-driving method is greatly affected.

Afterwards, a super impulse-driving method is provided to resolve the problem of deteriorated overall average luminance that occurs in the impulse-driving method. According to the super impulse-driving method, corresponding pixels are driven by a low gray level smaller than the target gray level during a first half period of each frame period, and then corresponding pixels are driven by a high gray level larger than the target gray level during a last period of each frame period. The average value of the low gray level and the high gray level is equal to the target gray level, such that the average luminance of overall pixels is maintained.

Despite the super impulse-driving method enabling the luminance of the pixels to be outputted impulsively and the average luminance of overall pixels is maintained, the large difference between the low gray level in the first half period of each frame period and the high gray level in the last period of each frame period cause the image frame to flicker in a single frame period and eventually affects the quality of the image frame.

### BRIEF DESCRIPTION OF THE DRAWINGS

FIG. 1 shows a block diagram of a flat display according to an embodiment;

FIG. 2 shows a flowchart of a method of driving a flat display according to an embodiment;

FIGS. 3A-3D show various pixels of the flat display according to some embodiments;

FIG. 4 shows a flowchart of a method of driving a flat display according to another embodiment;

FIGS. 5A-5D show various pixels of the flat display according to further embodiments.

### DETAILED DESCRIPTION

The disclosure provides a flat display and method of driving the same. By changing the order of the low gray level and the high gray level in super impulse-driving method, the flat display under super impulse-driving mode not only maintains average luminance of overall pixels but also resolves the problem of flickering frame.

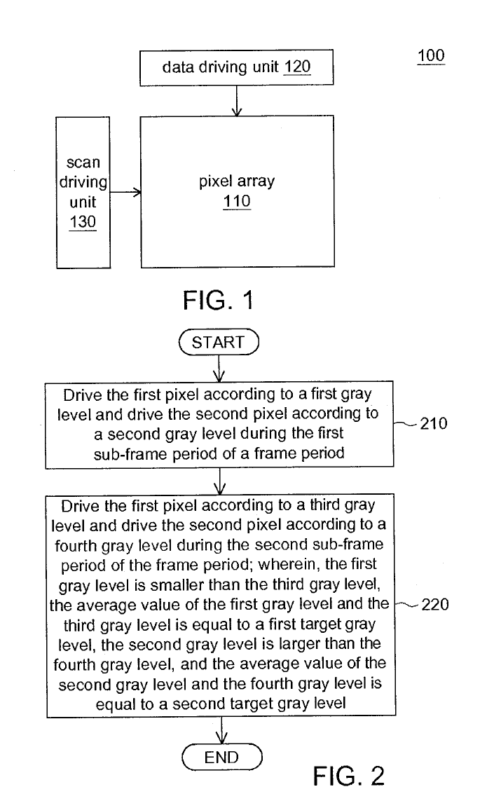

FIG. 1 displays a block diagram of a flat display. The flat display 100, such as a liquid crystal display, includes a pixel array 110, a data driving unit 120 and a scan driving unit 130. The pixel array 110 has multiple pixels (not illustrated in the diagram), wherein the pixels at least include a first pixel and a second pixel. The first pixel and the second pixel can be adjacent or not adjacent to each other. The data driving unit 120 is used for driving the pixels. The scan driving unit 130 is used for enabling the pixels. The display mode of the flat display 100 substantially is super impulse-driving mode.

FIG. 2, a flowchart of an embodiment of a method of driving a flat display. Firstly, the method begins at step 210, the data driving unit 120 drives the first pixel according to a first gray level and drives the second pixel according to a second gray level during the first sub-frame period of a frame period. Then, in step 220, the data driving unit 120 drives the first pixel according to a third gray level and drives the second pixel according to a fourth gray level during the second sub-frame period of the frame period. The first gray level is smaller than the third gray level. The average value of the first gray level and the third gray level is equal to a first target gray level. The second gray level is larger than the fourth gray level. The average value of the second gray level and the fourth gray level is equal to a second target gray level.

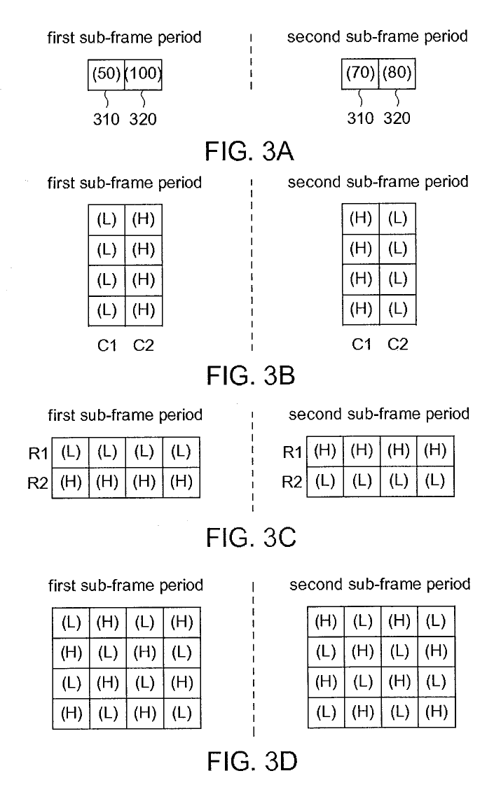

FIG. 3A, an embodiment of the pixel of the flat display, in which the pixels 310 and 320 are adjacent to each other. In FIG. 3A, the pixel 310 corresponds to a first target gray level 60, and the pixel 320 corresponds to a second target gray level 90. Firstly, the data driving unit 120 drives the pixel 310 according to the gray level 50 and drives the pixel 320 according to the gray level 100 during the first sub-frame period. Then, the data driving unit 120 drives the pixel 310 according to the gray level 70 and drives the pixel 320 according to the gray level 80 during the second sub-frame period.

Thus, the gray level 50 is smaller than the gray level 70. The average value of the gray level 50 and the gray level 70 is equal to the first target gray level 60. The gray level 100 is larger than gray level 80. The average value of the gray level 100 and the gray level 80 is equal to a second target gray level 90. Thus, the luminance of the pixel 310 and the pixel 320 is outputted impulsively and the average luminance of overall pixels is maintained. Besides, the overall luminance of the pixel 310 is equal to the overall luminance of the pixel 320 during the first sub-frame period and the second sub-frame period respectively, hence resolving the problem of flickering frame. Furthermore, if the first target gray level is equal to the second target gray level, the motion picture response curve (MPRC) of the pixel 310 will be identical to the motion picture response curve of the pixel 320 within the frame period, i.e. the first pixel response is equal to the second pixel response. Thus, the response rate of liquid crystal will not slow down when the driving method is adopted. Although in the embodiment specifically disclosed in FIG. 3A, the pixel 310 and the pixel 320 are adjacent to each other, further embodiments are not limited thereto.

FIG. 3B shows another embodiment of the pixel of the flat display. In FIG. 3B, during the first sub-frame period, the first column pixel C1 is driven by a low gray level (L) smaller than the target gray level, and the second column pixel C2 is driven by a high gray level (H) larger than the target gray level. After that, during the second sub-frame period, the first column pixel C1 is driven by a high gray level (H) larger than the target gray level, and the second column pixel C2 is driven by a low gray level (L) smaller than the target gray level. The average value of the low gray level and the high gray level is equal to the target gray level.

FIG. 3C shows an embodiment of the pixel of the flat display. In FIG. 3C, during the first sub-frame period, the first row pixel R1 is driven by a low gray level (L), and the second row pixel R2 is driven by a high gray level (H). After that, during the second sub-frame period, the first row pixel R1 is driven by a high gray level (H), and the second row pixel R2 is driven by a low gray level (L). FIG. 3D shows another embodiment of the pixel of the flat display. In FIG. 3D, all pixels are alternately driven by the low gray level (L) and the high gray level (H) at different positions during different sub-frame periods.

In practical application, the embodiments are not limited to driving the pixel array 110 in a specific pattern. Besides, despite the ratio of the first sub-frame period to the second sub-frame period substantially is 1:1 (that is, the pixel array 110 is driven at double frame updating frequency), the embodiments are not limited thereto. Any designs of the pixel array 110 enabling the average luminance of overall pixels during the first sub-frame period to be substantially equal to average luminance of overall pixels during the second sub-frame period are within the scope of protection.

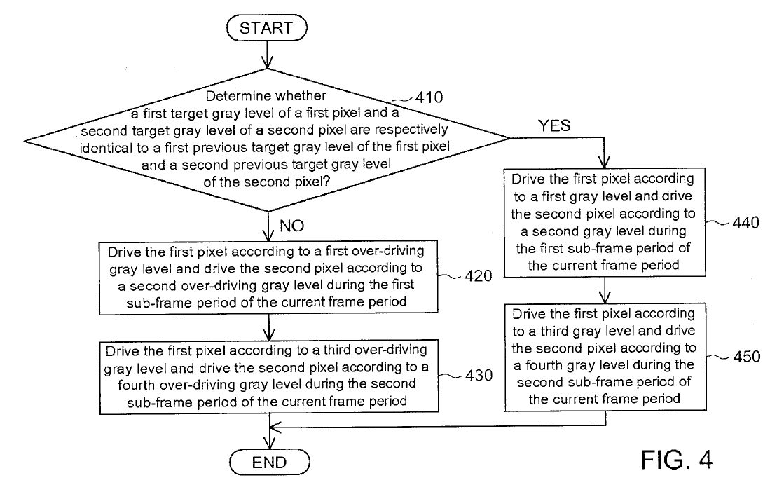

Besides, the disclosure is applicable to both the motion picture frame and the static picture frame. FIG. 4 shows a flowchart of an embodiment of a method of driving a flat display. Firstly, the method begins at step 410, whether a first target gray level of a first pixel and a second target gray level of a second pixel are respectively identical to a first previous target gray level of the first pixel and a second previous target gray level of the second pixel is determined. The first target gray level and the second target gray level correspond to a current frame period. The first previous target gray level and the second previous target gray level correspond to a previous frame period.

If the first target gray level and the second target gray level are respectively different from the first previous target gray level and the second previous target gray level, then the method proceeds to step 420, the first pixel is driven according to a first over-driving gray level and the second pixel is driven according to a second over-driving gray level during the first sub-frame period of the current frame period. Then, the method proceeds to step 430, the first pixel is driven according to a third over-driving gray level and the second pixel is driven according to a fourth over-driving gray level during the second sub-frame period of the current frame period. The average value of the first over-driving gray level and the third over-driving gray level is equal to a first target over-driving gray level. The average value of the second over-driving gray level and the fourth over-driving gray level is equal to a second target over-driving gray level. The first target over-driving gray level is substantially obtained by looking up the table according to the first previous target gray level and the first target gray level. The second target over-driving gray level is substantially obtained by looking up the table according to the second previous target gray level and the second target gray level.

If the first target gray level and the second target gray level respectively are equal to the first previous target gray level and the second previous target gray level, then the method proceeds to step 440, the first pixel is driven according to a first gray level and the second pixel is driven according to a second gray level during the first sub-frame period of the current frame period. After that, the method proceeds to step 450, the first pixel is driven according to a third gray level and the second pixel is driven according to a fourth gray level during the second sub-frame period of the current frame period. The first gray level is substantially smaller than the third gray level. The average value of the first gray level and the third gray level is equal to the first target gray level. The second gray level is substantially larger than the fourth gray level. The average value of the second gray level and the fourth gray level is equal to the second target gray level.

In the flat display and method of driving the same disclosed above, a pixel is the display unit. However, this is not intended to limit the scope of the disclosure. The single pixel substantially includes three sub-pixels respectively used for displaying red, green and blue. More than three sub-pixels and/or other colors can be used in each pixel. Other embodiments where a sub-pixel is a display unit can also be used, and the operating theories are already disclosed above and are not repeated here.

The flat display and method of driving the same disclosed above substantially adopts a super impulse-driving mode. Within a first sub-frame period of a single frame period, a part of the pixels is driven in an order of low gray level first and high gray level next, and the remaining pixels are driven in a sequence of high gray level first and low gray level next. Then, within a second sub-frame period of the single frame period, a part of the pixels is driven in an order of high gray level first and low gray level next, and the remaining pixels are driven in an order of low gray level first and high gray level next. Thus, the average luminance of overall pixels in the flat display during the first sub-frame period is substantially equal to the average luminance of overall pixels during the second sub-frame period. Thus, under the super impulse-driving mode, the flat display not only maintains the average luminance of overall pixels but also resolves the problem of flickering frame.

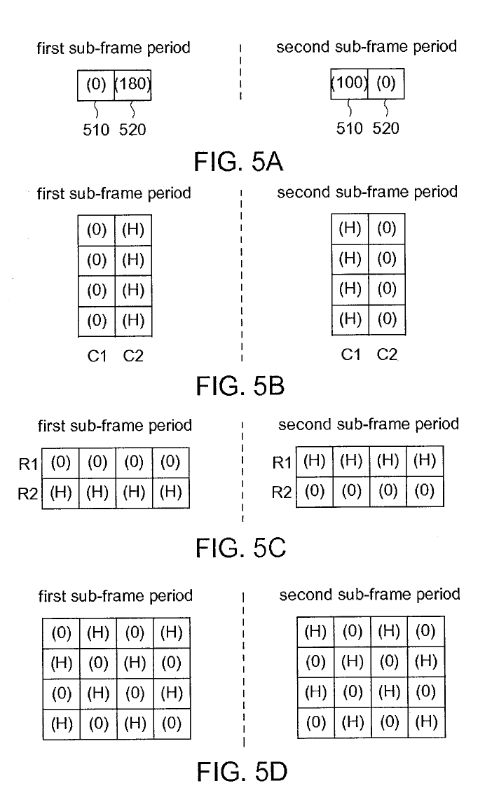

Further embodiments can also be implemented under an impulse-driving mode. FIG. 5A shows an embodiment of the pixel of the flat display, in which the pixels 510 and 520 are adjacent to each other. In FIG. 5A, the pixel 510 corresponds to the first target gray level 50, and the pixel 520 corresponds to the second target gray level 90. Firstly, the data driving unit 120 drives the pixel 510 according to the black frame signal, and drives the pixel 520 according to the gray level 180 during the first sub-frame period. Then, the data driving unit 120 drives the pixel 510 according to the gray level 100, and drives the pixel 520 according to the black frame signal during the second sub-frame period.

Thus, the pixel 510 and the pixel 520 output the luminance impulsively. Also, the difference between the overall luminance of the first sub-frame period and that of the second sub-frame period is reduced, and the problem of flickering frame is effectively decreased. Although in the embodiment specifically disclosed in FIG. 5A, the pixel 510 and the pixel 520 are adjacent to each other, further embodiments are not limited thereto.

FIG. 5B shows another embodiment of the pixel of the flat display. In FIG. 5B, the first column pixel C1 is driven by a black frame signal and the second column pixel C2 is driven by a high gray level (H) larger than the target gray level during the first sub-frame period. After that, the first column pixel C1 is driven by a high gray level (H) larger than the target gray level and the second column pixel C2 is driven by a black frame signal during the second sub-frame period. The average value of the black frame signal and high gray level is equal to the target gray level.

FIG. 5C shows an embodiment of the pixel of the flat display. In FIG. 5C, the first row pixel R1 is driven by the black frame signal and the second row pixel R2 is driven by a high gray level (H) during the first sub-frame period. After that, the first row pixel R1 is driven by a high gray level (H) and the second row pixel R2 is driven by the black frame signal during the second sub-frame period. FIG. 5D shows an embodiment of the pixel of the flat display. In FIG. 5D, all pixels are alternately driven by the black frame signal and the high gray level (H) during different sub-frame periods and different positions.

In practical application, further embodiments are not limited to driving the pixel array 110 according to a specific pattern. Besides, despite the ratio of the first sub-frame period to the second sub-frame period substantially is 1:1 (that is, the pixel array 110 is driven at double frame updating frequency), however, further embodiments are not limited thereto. Any designs of the pixel array 110 enabling the average luminance of overall pixels during the first sub-frame period to be substantially equal to average luminance of overall pixels during the second sub-frame period are within the scope of protection.

While the disclosure has been described by way of example, it is to be understood that the disclosure should not be limited thereto. On the contrary, it is intended to cover various modifications and similar arrangements and procedures.

What is claimed is:

1. A flat display, comprising:
a pixel array having a plurality of pixels, wherein the pixels at least comprise a first pixel and a second pixel;
a scan driving unit for enabling the pixels; and
a data driving unit for driving the first and second pixels
during a first sub-frame period of a frame period, to a first gray level and a second gray level, respectively, and
during a second sub-frame period of the frame period, to a third gray level and a fourth gray level, respectively;
wherein the first gray level is smaller than the third gray level, the first gray level and the third gray level average to a first target gray level, the second gray level is larger than the fourth gray level, and the second gray level and the fourth gray level average to a second target gray level.

2. The flat display according to claim 1, wherein an average luminance of overall said pixels during the first sub-frame period is substantially equal to the average luminance of overall said pixels during the second sub-frame period.

3. The flat display according to claim 1, wherein the first target gray level is equal to the second target gray level, the motion picture response curve of the first pixel (MPRC) is identical to the motion picture response curve of the second pixel within the frame period.

4. The flat display according to claim 1, wherein the data driving unit is configured for driving the pixels in a super impulse-driving mode.

5. The flat display according to claim 1, wherein the first pixel is adjacent to the second pixel.

6. The flat display according to claim 1, wherein the first pixel is not adjacent to the second pixel.

7. The flat display according to claim 1, wherein the first sub-frame period is equal to the second sub-frame period.

8. The flat display according to claim 1, wherein the first gray level and the fourth gray level are black frame signals.

9. The flat display according to claim 1, wherein the flat display is a liquid crystal display.

10. A method of driving a flat display, wherein the flat display has a plurality of pixels at least comprising a first pixel and a second pixel, and the method comprises:
driving the first pixel and the second pixel to a first gray level and a second gray level, respectively, during a first sub-frame period of a frame period; and
driving the first pixel and the second pixel to a third gray level and a fourth gray level during a second sub-frame period of the frame period;
wherein, the first gray level is smaller than the third gray level, the first gray level and the third gray level average to a first target gray level, the second gray level is larger than the fourth gray level, and the second gray level and the fourth gray level average to a second target gray level.

11. The method according to claim 10, wherein an average luminance of overall said pixels during the first sub-frame period is substantially equal to the average luminance of overall said pixels during the second sub-frame period.

12. The method according to claim 10, wherein the first target gray level is equal to the second target gray level, the motion picture response curve of the first pixel is identical to the motion picture response curve of the second pixel within the frame period.

13. The method according to claim 10, wherein the flat display is driven according to a super impulse-driving mode.

14. The method according to claim 10, wherein the first pixel is adjacent to the second pixel.

15. The method according to claim 10, wherein the first pixel is not adjacent to the second pixel.

16. The method according to claim 10, wherein the first sub-frame period is equal to the second sub-frame period.

17. The method according to claim 10, wherein the flat display is a liquid crystal display.

18. The method according to claim 10, wherein the first gray level and the fourth gray level are black frame signals.

19. A method of driving a flat display comprising at least a first pixel and a second pixel, said method comprising:
determining whether a first target gray level of the first pixel and a second target gray level of the second pixel are respectively identical to a first previous target gray level of the first pixel and a second previous target gray level of the second pixel, wherein the first target gray level and the second target gray level correspond to a current frame period, and the first previous target gray level and the second previous target gray level correspond to a previous frame period; and
if the first target gray level and the second target gray level are respectively different from the first previous target gray level and the second previous target gray level,
driving the first pixel according to a first over-driving gray level and driving the second pixel according to a second over-driving gray level during a first sub-frame period of the current frame period, and
driving the first pixel according to a third over-driving gray level and driving the second pixel according to a fourth over-driving gray level during a second sub-frame period of the current frame period;
wherein
an average value of the first over-driving gray level and the third over-driving gray level is equal to a first target over-driving gray level,
an average value of the second over-driving gray level and the fourth over-driving gray level is equal to a second target over-driving gray level,
the first target over-driving gray level corresponds to the first previous target gray level and the first target gray level,
the second target over-driving gray level corresponds to the second previous target gray level and the second target gray level;
the first over-driving gray level is smaller than the third over-driving gray level, and
the second over-driving gray level is larger than the fourth over-driving gray level.

20. The method according to claim 19, further comprising, if the first target gray level and the second target gray level are respectively equal to the first previous target gray level and the second previous target gray level:
driving the first pixel to a first gray level and driving the second pixel to a second gray level during the first sub-frame period of the current frame period; and
driving the first pixel to a third gray level and driving the second pixel to a fourth gray level during the second sub-frame period of the current frame period;
wherein, an average value of the first gray level and the third gray level is equal to the first target gray level, and an average value of the second gray level and the fourth gray level is equal to the second target gray level; and
wherein, the first gray level is smaller than the third gray level, and the second gray level is larger than the fourth gray level.
